(19) United States
(12) Patent Application Publication
(10) Pub. No.: US 2008/0099429 A1
(43) Pub. Date: May 1, 2008

(54) METHODS FOR REPAIRING PATTERNED STRUCTURES OF ELECTRONIC DEVICES

(75) Inventors: Chao-Kai Cheng, Miaoli County (TW); Chieh-Yi Huang, Hsinchu County (TW); Wan-Wen Chiu, Hsinchu County (TW); Chun-Hung Lin, Taipei City (TW); Chia-Chang Chang, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 11/828,321

(22) Filed: Jul. 25, 2007

(30) Foreign Application Priority Data
Oct. 25, 2006 (TW) TW95139325

(51) Int. Cl. H01B 13/00

(52) U.S. Cl. 216/21; 216/23; 216/38; 216/53; 216/65; 216/66; 216/67

(57) ABSTRACT

Methods for repairing patterned structure of electronic devices. A first substrate with a patterned structure thereon is provided, wherein the patterned structure includes at least one defect. The defect corresponds to a defect region while the patterned structure corresponds to a main region. A first surface treatment is performed on the defect region such that the surface characteristics on the defect region are different from those on the main region. The defect region is repaired by inkjet printing. A second surface treatment is performed on the defect region such that the surface characteristics on the defect region are the same as those on the main region.

### BACKGROUND OF THE INVENTION

1. Field of the Invention

The invention relates to methods for fabrication of electronic devices, and in particular to methods for repairing patterned structures of electronic devices.

2. Description of the Related Art

Conventional front-end processes for fabricating thin film transistor liquid crystal display (TFT-LCD) devices includes fabrication of a color filter (CF) substrate, a thin film transistor substrate, a driver IC, a backlight module and liquid crystal materials. Among the production costs for conventional TFT-LCD devices, material costs account for about 60% to 70%. Particularly, costs of the color filter can reach almost ¼ of the total material cost of the TFT-LCD devices. As the applications for TFT-LCD devices become wider and wider, demand for color filters also increases. Generally, more than 20% of color filters contain defects and require repairing. Thus, it is critical to fabricate a high quality color filter and develop color repairing technique to further improve fabrication yield of the TFT-LCD devices.

In order to solve defect problems during fabrication of pixellization structure likes color filter, pixel electrode, black matrix, photo spacer etc., a method for fabricating said structure, for example, the well known of color filters using an inkjet printing system has been explained. Recently a new color filter fabrication method by inkjet printing requires a precisely controlled platform dispensing inkjet droplets on predetermined patterned pixel regions. The color droplets on the patterned pixel regions must not overflow to adjacent pixel regions to prevent color mixing. Moreover, the pattern and resolution of the color filters depend greatly on the nozzle interval of an inkjet printhead, resulting in increased fabrication complexity.

Conventional color filter fabrication method includes forming a plurality of red, green and blue color dots on a glass substrate. Each color dot grouping corresponds to a pixel of the TFT-LCD device. The color filter fabrication method includes pigment dispersion. First, a light shielding pattern such as a black matrix is formed by sequentially deposition, lithography and etching. A color filter including red, green, and blue pigments is next formed by photolithography. The shape, dimensions, and arrangements of the color filter can be changed dependant upon the application of the TFT-LCD device. Lastly an indium tin oxide (ITO) layer is deposited on the color filter to serve as an electrode of the TFT-LCD devices.

During fabrication of the conventional color filter, however, defects are generated on the color filter. Conventional methods for repairing color filters include laser burning to repair color mixing regions or removal of particulates attached on the color filter. The conventional repairing method is unable to patch color omission and color irregularity caused by improper surface treatment.

U.S. Pat. No. 5,714,195, the entirety of which is hereby incorporated by reference discloses a method for repairing color filters. Defects, such as color omission or color irregularity on the color filter is repaired by inkjet printing. Color pigment is injected on the defects by a printhead to repair color defects. FIG. 1 is a flowchart showing a conventional method for repairing color filters. The conventional method for repairing color filters starts after a color filter is manufactured (S10). The color filter is tested, and a repair procedure is implemented if color defects are detected. The repair procedure includes testing and sequentially repairing the color filter (S30) by an apparatus for testing and repairing. Alternatively, the repair procedure includes first testing the color filter (S20). If the color filter is detected without defect, a non defective color filter is obtained (S40). On the other hand, if defects are detected, repairing color filter step (S25) is performed until a non defective color filter is obtained (S40).

Repairing pixellization structure for color filter, pixel electrode, black matrix etc. by inkjet printing is beneficial by directly injecting ink on pixel regions. The difference between versatile applications is their treatment method after inkjet printing, and the same is all these applications need pre-treatment on surface characteristics before ink-jet printing certain ink. In this innovation, it mentioned a pre-treatment method before operation the repair on pixellization by ink-jet printing for versatile known pixellization structure in TFT-:LCD, but not limited only on color filter repairing. Compared with other dry film repairing methods, the inkjet printing repairing method is beneficial due to its simplicity, low cost for production and high yield.

U.S. Pat. Nos. 6,479,120 and 6,228,464, the entirety of which are hereby incorporated by references disclose a circuitry pattern repairing method by screen printing. Referring to FIG. 2, a substrate 10 with a circuitry pattern 12 is provided. The circuitry pattern 12 is formed by screen printing. The circuitry pattern 12 having a defect region (broken line) is repaired by attaching a transparent plate 20 on the substrate 10. The transparent plate 20 includes a repairing pattern 24 covering the defect region. The repairing pattern 24 is transferred to the defect region by hot pressing 50 or printing. After illuminating and heat treatment to evaporate solvent and adhesion agents, repairing procedure for the circuitry pattern 12 is completed.

Conventional methods for repairing circuitry pattern, however, do not consider the surface condition between the circuitry pattern on the substrate and the repairing pattern on the transparent plate. The repaired defect region may contain unevenness affecting the fabrication processes. Furthermore, when the conventional method for repairing circuitry pattern is applied to a high resolution display panel, the aforementioned problems cause a need for intricate fabrication procedures, resulting in high production cost and low yield.

### BRIEF SUMMARY OF THE INVENTION

A detailed description is given in the following embodiments with reference to the accompanying drawings.

The invention is directed to a method for analyzing, repairing and patching defects of circuitry patterns, thereby enhancing device performance, improving production yield and reducing production cost.

An embodiment of the invention provides a method for repairing patterned structures of electronic devices. A substrate with a patterned structure thereon is provided, wherein the patterned structure includes at least one defect corresponding to a defect region while the patterned structure corresponds to a main region. A first surface treatment is performed on the defect region such that the surface characteristics on the defect region are different from those on the main region. A defect repairing procedure is performed. A second surface treatment is performed on the defect region such that the surface characteristics on the defect region are the same as those on the main region.

Another embodiment of the invention further provides a method for repairing patterned structures of electronic devices. A substrate with a patterned structure comprising a color filter structure for display device, a thin film transistor array structure or a printed circuit structure thereon is provided, wherein the patterned structure includes at least one defect corresponding to a defect region while the patterned structure corresponds to a main region. A residue on the defect region is removed. A first surface treatment is performed on the defect region such that the surface characteristics on the defect region are different from those on the main region. A defect repairing procedure is performed on a repaired region. Planarization is performed to remove unevenness on the repaired region. A second surface treatment is performed on the defect region such that the surface characteristics on the defect region are the same as those on the main region.

### BRIEF DESCRIPTION OF THE DRAWINGS

The present invention can be more fully understood by reading the subsequent detailed description and examples with references made to the accompanying drawings, wherein:

FIG. 1 is a flowchart showing a conventional method for repairing color filters;

FIG. 2 is a schematic view of a conventional circuitry pattern repairing method by screen printing;

FIG. 3 is a flowchart showing an exemplary embodiment of a method for repairing defects on a color filter pattern of the invention;

FIGS. 4A-4D are cross sections of a first embodiment of a method for repairing patterned color filter structures during various stages of the fabrication process;

FIGS. 5A-5E are cross sections of a second embodiment of a method for repairing patterned color filter structures during various stages of the fabrication process; and

FIGS. 6A-6F are cross sections of a third embodiment of a method for repairing patterned color filter structures during various stages of the fabrication process.

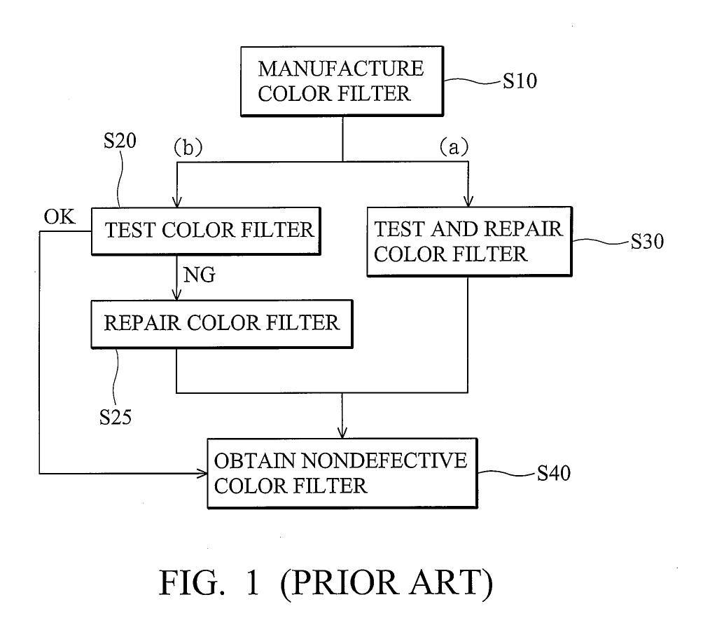

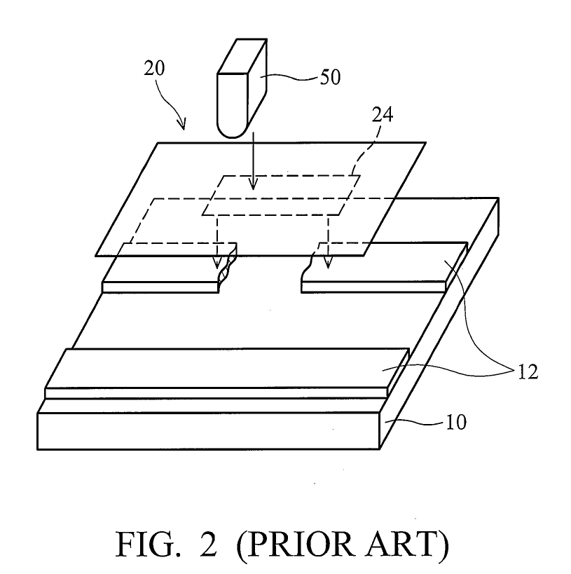

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provide methods for repairing defects on circuitry patterns using inkjet printing to repair and patch aforementioned defect problems. An atmospheric plasma surface treatment is also provided to locally change surface conditions on the defect regions such that the surface characteristics on the defect regions are different from those on the non-defective regions. The defect region is patched by injecting the same material. For example, when a repairing droplet is ejected from a printhead to a defect region on the substrate, the defect region is sequentially repaired. A second surface treatment is performed on the substrate such that the surface characteristics on the repaired region are the same as those on the non-defective region, thus improving production yield. While embodiments of the invention are described in conjunction with an example of a method for repairing color filter patterns, the features of the embodiments of the invention may also be applied to methods for repairing other electron circuitry patterns such as indium tin oxide (ITO) electrode patterns, screen printing circuits, and electroplating patterns.

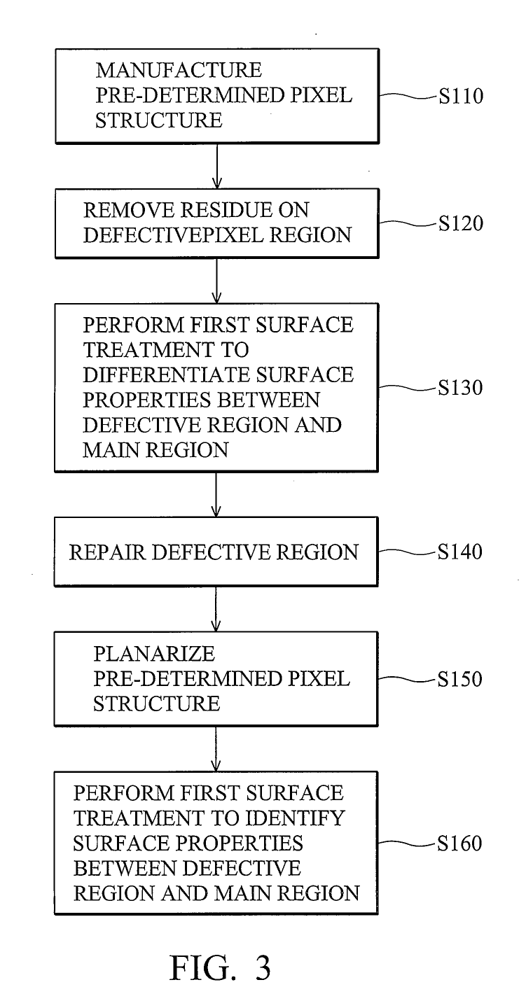

FIG. 3 is a flowchart showing an exemplary embodiment of a method for repairing defects on a color filter pattern of the invention. A pre-determined pixel structure is manufactured on a substrate (S110). The pre-determined pixel structure includes transparent electrodes, black matrix, photo spacer, and the like. Manufacturing of pre-determined pixel structure applicable to liquid crystal display panel or other flat panel display devices comprises dye or pigment dispersion, printing, electroplating or inkjet printing. A testing procedure is performed to analyze the color filter. After testing the color filter, defect regions on the color filter are traced and located. Residue on the defect regions are removed (S120) leaving a color omission region. A first surface treatment is performed on the defect region such that the surface characteristics on the defect region are different from those on the main region (S130).

Subsequently, a defect repairing procedure is performed on a defect region (S140). For example, the defect region is repaired and patched by inkjet printing. Planarization is then performed to remove unevenness on the defect region (S150). A second surface treatment is performed on the defect region such that the surface characteristics on the defect region are the same as those on the main region (S160).

Surface treatments of some embodiments of the invention comprise a physical surface treatment (e.g., performing an atmospheric plasma surface treatment) or a chemical surface treatment (e.g., applying a surface modifier). Surface conditions such as polarity and hydrophile-lipophile transition of the defect region is modified in accordance with inkjet printing to repair the defect region.

According to an exemplary embodiment of the invention, it is beneficial that an atmospheric plasma surface treatment is performed to remove color resist residue on the boundary or to remove local defects on the black matrix (BM) structure. Removing residue on the defect region will cause color omission which is repaired or patched by inkjet printing. Atmospheric plasma surface treatment is particularly efficient in removing organic residue on the boundary or the black matrix structure, without damaging the underlying boundary or black matrix structure.

Moreover, before repairing defect regions, a surface treatment (e.g., an atmospheric plasma surface treatment) can be optionally performed to change surface condition to hydrophobic or lipophilic. If the defect regions are initially hydrophobic, the surface treatment can be omitted. The inkjet droplet for repairing may not fix the defect regions due to surface condition differences, resulting in displacement of the inkjet droplet. In order to solve this problem, the defect region is locally treated by atmospheric plasma to transform into hydrophobic. After repairing defect regions by inkjet printing and subsequent curing, a non-diffused repaired color filter region is achieved.

After the defect region is repaired, planarization is needed to remove unevenness on a repaired region. Furthermore, another surface treatment is performed on the repaired region to change the surface condition back to hydrophilic for the subsequent fabrication processes. For example, when an indium tin oxide (ITO) electrode is subsequently deposited on the repaired color filter, defects would not be formed due to hydrophobic of the repaired defect region of the color filter.

The implementation techniques described hereinabove and hereinbelow may but need not necessarily include techniques described in U.S. Pat. No. 6,342,275, the disclosure of which is hereby incorporated by reference. An atmospheric plasma apparatus is used to treat and modify surface conditions of organic devices. Typically, atmospheric plasma treatment uses a radio frequency (RF) discharge generator as a driver to excite inert gas (e.g., He) and mixer gas (e.g., O₂) generating free radicals including O, OH, H, and F radicals for surface treatment.

Some embodiments of the invention will be described with reference to the attached drawings. For explanation and comparison purposes, we describe the following three embodiment methods for repairing patterned structures of electronic devices as examples.

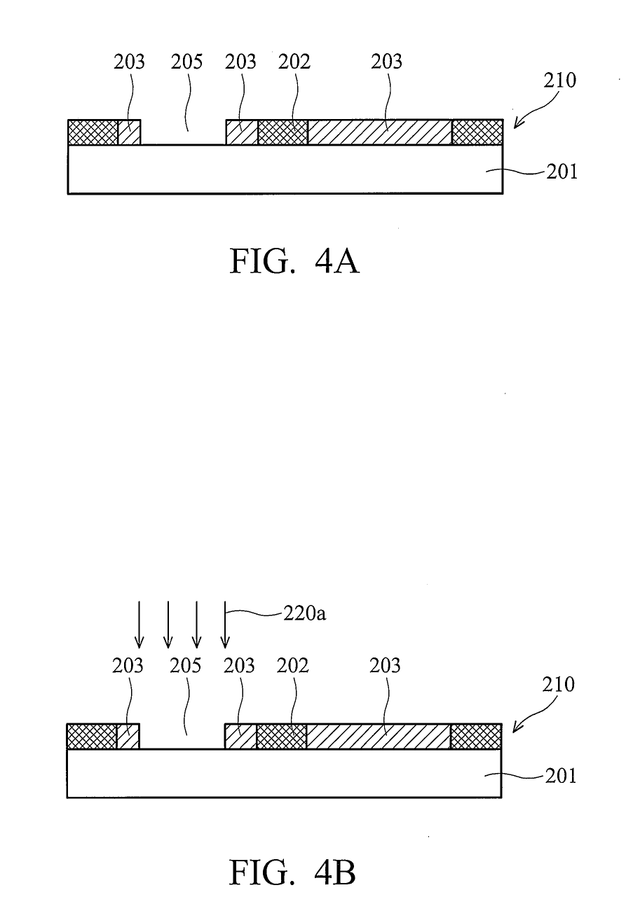

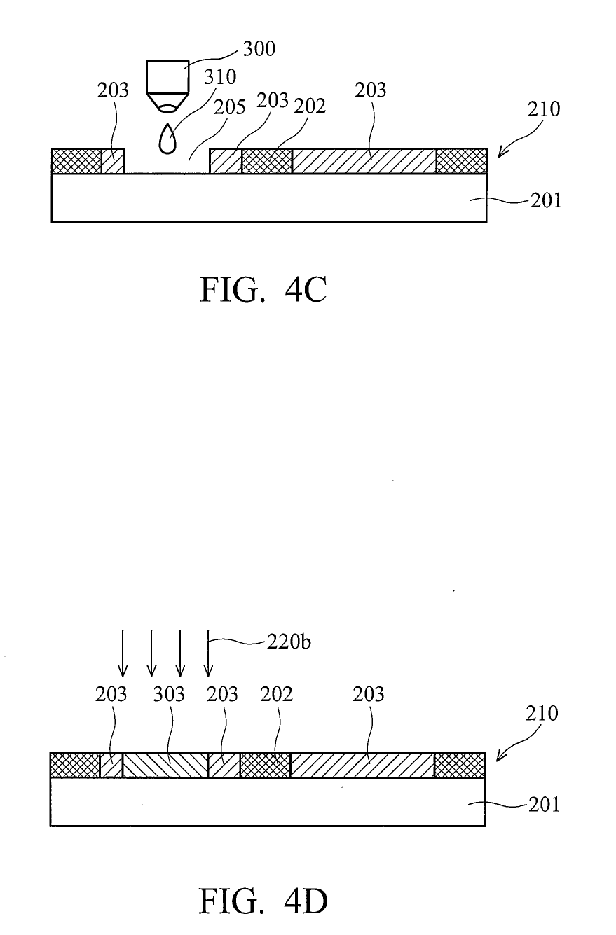

FIGS. 4A-4D are cross sections of a first embodiment of a method for repairing patterned color filter structures during various stages of the fabrication process. Referring to FIG. 4A, a substrate 201 with a preliminary color filter structure 210 thereon is provided. The color filter structure 210 can be of any color filter type, for example comprising red, green, and blue color resists pixels 203. A black grid matrix 202 structure is disposed among each color resists pixels 203. During fabrication of the color filter structure 210, defect regions 205 such as color omission or color irregularity may occur, while the other non-defective patterned color filter structure 210 corresponding to the main region, remains.

Referring to FIG. 4B, a first surface treatment 220a is performed on the defect region 205 such that the surface characteristics on the defect region are different from those on the main region. The first surface treatment 220a comprises a physical surface treatment and a chemical surface treatment. Fore example, the physical surface treatment can be achieved by an atmospheric plasma surface treatment, while the chemical surface treatment can be achieved by applying a surface modifier on the defect region 205.

Referring to FIG. 4C, the defect region 205 such as color omission or color irregularity is repaired or patched. For example, inkjet printing is performed according to the original color of the defect region. Color resist droplet 310 is ejected from a inkjet printhead device 300 on the defect region 205 of the substrate 201. After repairing defect regions by inkjet printing and subsequent curing, a non-diffusive repaired color filter region 303 is achieved, as shown in FIG. 4D.

Referring to FIG. 4D, a second surface treatment 220b is performed on the repaired defect region 303 such that the surface characteristics on the repaired defect region 303 are the same as those on the main region. For example, the second surface treatment is performed on the repaired region to change the surface condition back to hydrophilic for subsequent fabrication. The second surface treatment 220b can be the same as the first surface treatment 220a. Fore example, the physical surface treatment can be achieved by an atmospheric plasma surface treatment, while the chemical surface treatment can be achieved by applying a surface modifier on the repaired defect region 303.

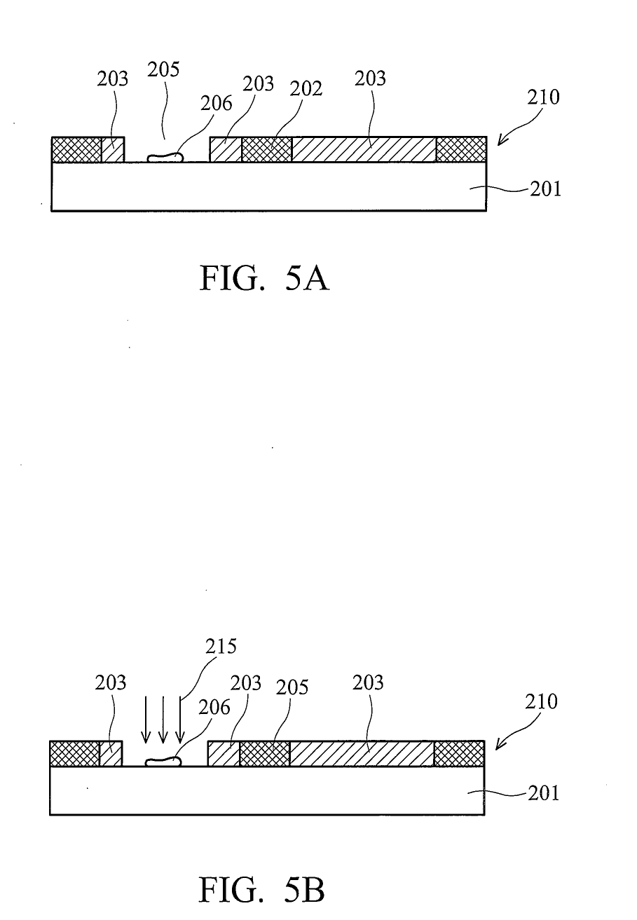

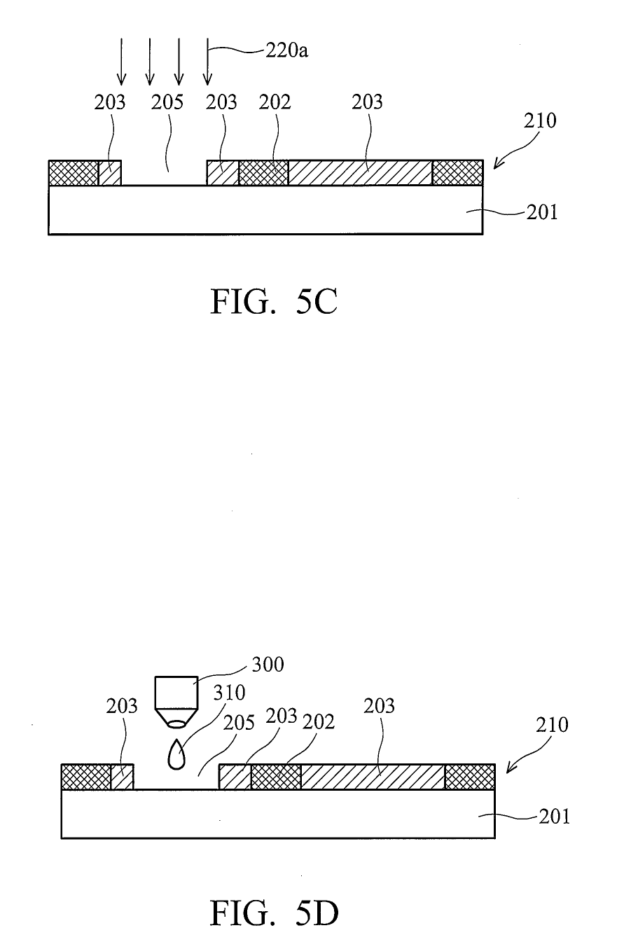

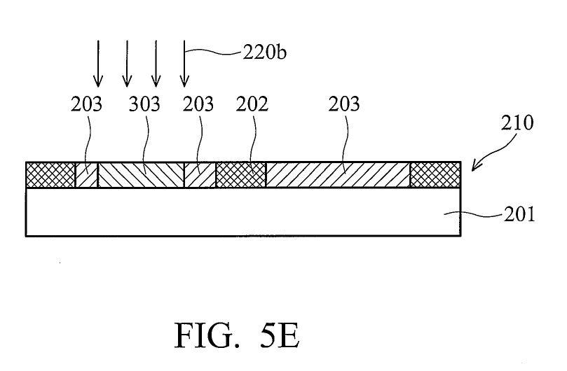

FIGS. 5A-5E are cross sections of a second embodiment of a method for repairing patterned color filter structures during various stages of the fabrication process. The second embodiment of a method for repairing patterned color filter structures is nearly identical to the first embodiment of a method for repairing patterned color filter structures and for simplicity, related detailed descriptions are omitted. The second embodiment is different from the first embodiment in that residue matter 206 resides in the defect region 205, as shown in FIG. 5A.

Referring to FIG. 5B, A step 215 of removing the residue matter 206 in the defect region 205 is subsequently performed. For example, the step 215 of removing the residue matter 206 on the defect region 205 comprises chemical mechanical polishing, wet etching, photo etching, laser ablating, plasma ashing, or ion-beam milling. The exemplary embodiment of the steps for repairing and patching patterned color filter structures of FIGS. 5C-5E are nearly identical to the repairing steps for patterned color filter structures of FIGS. 4B-4D of the first embodiment and for simplicity, related detailed descriptions are omitted.

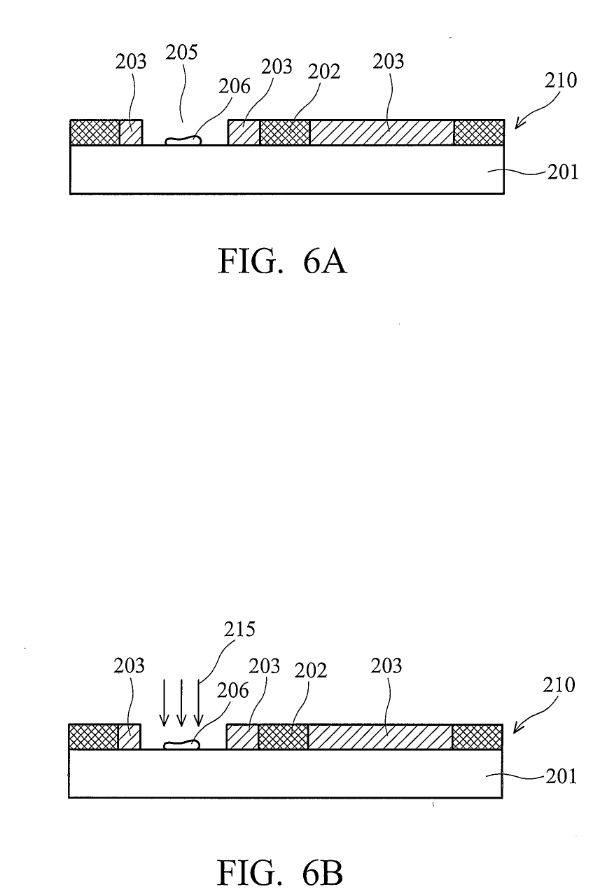

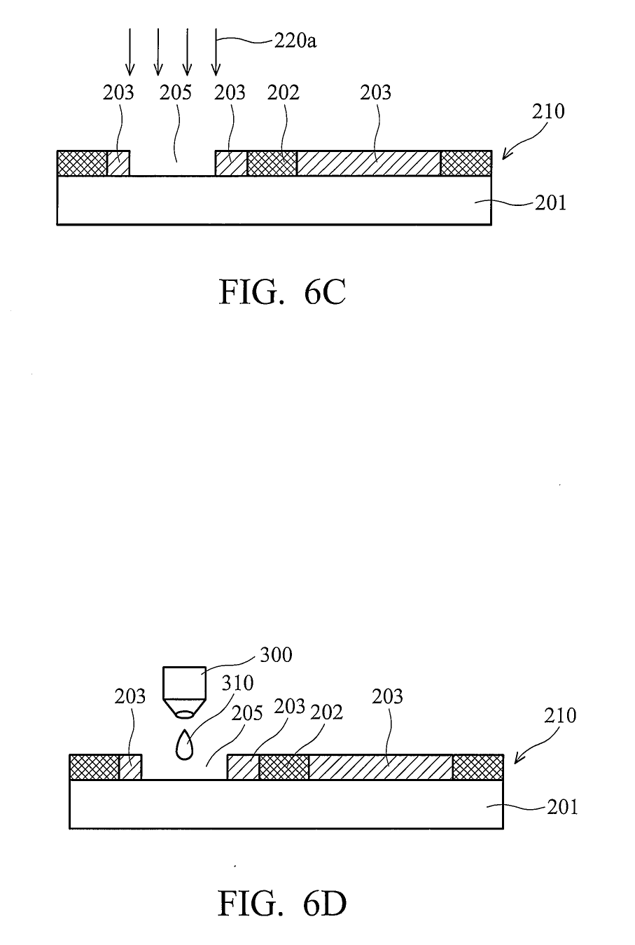

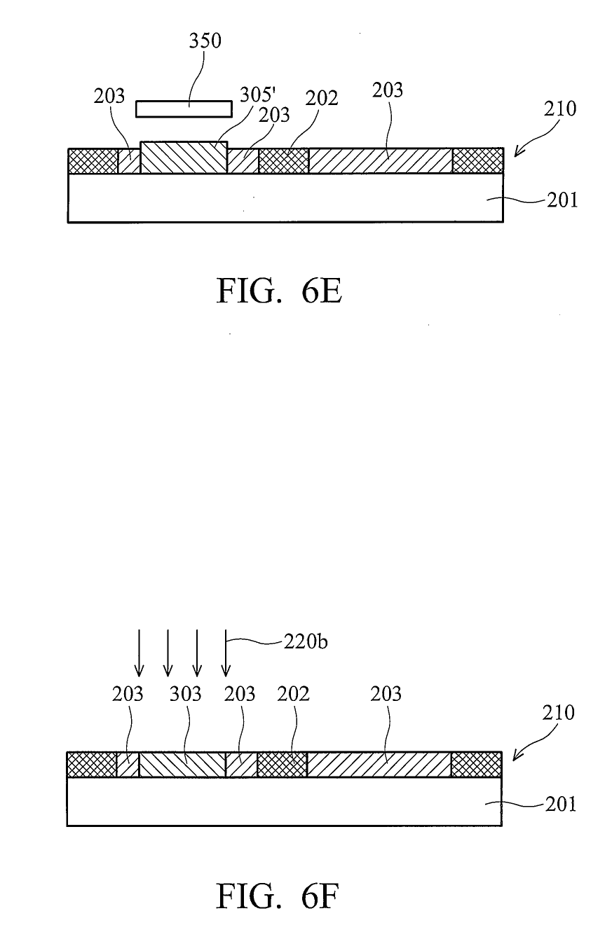

FIGS. 6A-6F are cross sections of a third embodiment of a method for repairing patterned color filter structures during various stages of the fabrication process. The third embodiment of a method for repairing patterned color filter structures is nearly identical to the second embodiment of a method for repairing patterned color filter structures shown in FIGS. 5A-5E. More specifically, the exemplary embodiment of steps of repairing and patching patterned color filter structures of FIGS. 6A-6D are nearly identical to the repairing steps for patterned color filter structures of FIGS. 5A-5E and for simplicity, related detailed descriptions are omitted. The third embodiment is different from the second embodiment in that when unevenness occurs at the patched layer 305′ on the defect region 205, a step of planarization is performed to remove unevenness on the repaired defect region.

Referring to FIG. 6E, after performing the defect repairing procedure, unevenness occurs at the patched layer 305′ on the defect region 205. Under this circumstance, a step of planarization 350 is performed to create an even repaired region 303. The step of planarization 350 comprises chemical mechanical polishing, wet etching, photo etching, laser ablating, plasma ashing, or ion-beam milling

Referring to FIG. 6F, a second surface treatment 220b is performed on the even repaired defect region 303 such that the surface characteristics on the even repaired region 303 are the same as those on the main region. For example, the second surface treatment is performed on the repaired region to change the surface condition back to hydrophilic for subsequently fabrication processes. The second surface treatment 220b can be the same as the first surface treatment 220a. For example, the physical surface treatment can be achieved by an atmospheric plasma surface treatment, while the chemical surface treatment can be achieved by applying a surface modifier on the repaired defect region 303.

Although these embodiments have been described in conjunction with an example of methods for repairing or patching patterned color filter structures, the features of these embodiments may also be applied to methods for repairing or patching patterned structures of electronic devices, such as thin film transistor (TFT) array for flat panel displays and other electron circuitry patterns (e.g., indium tin oxide (ITO) electrode patterns, screen printing circuits, electroplating patterns).

Some embodiments of the invention are beneficial in that defect regions of a patterned structure on an electronic substrate are locally repaired and patched by inkjet printing. The patterned structure can be, but is not limited to, a color filter, an electrode, an interconnect line or other predetermined micro-patterns. Using atmospheric plasma surface treatment, the surface characteristics on the defect region are different from those on the main region. A defect repairing procedure is performed on a repaired region according to desired repaired material. After the defected regions are repaired, a second surface treatment is performed on the defect region such that the surface characteristics on the defect region are the same as those on the main region for subsequent fabrication processes.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for repairing patterned structures of electronic devices, comprising:
providing a substrate with a patterned structure thereon, wherein the patterned structure includes at least one defect corresponding to a defect region while a patterned structure corresponds to a main region;
performing a first surface treatment on the defect region such that the surface characteristics on the defect region are different from those on the main region;
performing a defect repairing procedure; and
performing a second surface treatment on the defect region such that the surface characteristics on the defect region are the same as those on the main region.

2. The method as claimed in claim 1, wherein the patterned structure comprises a color filter structure for a display device, an electrode array for TFTs, a black matrix structure for liquid crystal display, a photo spacer structure for liquid crystal display, a thin film transistor array structure or a printed circuit structure on substrate.

3. The method as claimed in claim 1, before the step of performing a first surface treatment, further comprising removing a residue on the defect region.

4. The method as claimed in claim 3, wherein the step of removing a residue on the defect region comprises chemical mechanical polishing, wet etching, photo etching, laser ablating, plasma ashing, or ion-beam milling.

5. The method as claimed in claim 1, wherein the step of performing a first surface treatment comprises performing a physical surface treatment or performing a chemical surface treatment.

6. The method as claimed in claim 5, wherein the step of performing a physical surface treatment comprises an atmospheric plasma surface treatment.

7. The method as claimed in claim 5, wherein the step of performing a chemical surface treatment comprises applying a surface modifier.

8. The method as claimed in claim 1, wherein the step of performing a defect repairing procedure comprises performing inkjet printing.

9. The method as claimed in claim 8, after the step of performing a defect repairing procedure, further comprising performing planarization to remove unevenness on a repaired region.

10. The method as claimed in claim 9, wherein the step of planarization comprises chemical mechanical polishing, wet etching, photo etching, laser ablating, plasma ashing, or ion-beam milling.

11. A method for repairing patterned structures of electronic devices, comprising:
providing a substrate with a patterned structure, wherein the patterned structure includes at least one defect corresponding to a defect region while the patterned structure corresponds to a main region;
removing a residue on the defect region;
performing a first surface treatment on the defect region such that the surface characteristics on the defect region are different from those on the main region;
performing a defect repairing procedure on a repaired region;
performing planarization to remove unevenness on the repaired region; and
performing a second surface treatment on the defect region such that the surface characteristics on the defect region are the same as those on the main region.

12. The method as claimed in claim 11, wherein the patterned structure comprises a color filter structure for a display device, an electrode array for TFTs, a black matrix structure for liquid crystal display, a photo spacer structure for liquid crystal display, a thin film transistor array structure or a printed circuit structure on substrate.

13. The method as claimed in claim 11, wherein the step of removing a residue on the defect region comprises chemical mechanical polishing, wet etching, photo etching, laser ablating, plasma ashing, or ion-beam milling.

14. The method as claimed in claim 11, wherein the step of performing a first surface treatment comprises performing a physical surface treatment or performing a chemical surface treatment.

15. The method as claimed in claim 13, wherein the step of performing a physical surface treatment comprises an atmospheric plasma surface treatment.

16. The method as claimed in claim 13, wherein the step of performing a chemical surface treatment comprises applying a surface modifier.

17. The method as claimed in claim 11, wherein the step of performing a defect repairing procedure comprises performing inkjet printing.

18. The method as claimed in claim 11, wherein the step of planarization comprises chemical mechanical polishing, wet etching, photo etching, laser ablating, plasma ashing, or ion-beam milling.
